(19) United States
(12) Patent Application Publication
(10) Pub. No.: US 2020/0039050 A1
(43) Pub. Date: Feb. 6, 2020

(54) Device for Installing Expansion Bolts

(71) Applicants: Wang-Kuan Lin, Taichung City (TW); Chiu-Teng Ma, Taichung City (TW)

(72) Inventors: Wang-Kuan Lin, Taichung City (TW); Chiu-Teng Ma, Taichung City (TW)

(21) Appl. No.: 16/049,877

(22) Filed: Jul. 31, 2018

(51) Int. Cl. B25F 5/00; B25B 21/00; B25F 5/02

(52) U.S. Cl. CPC B25F 5/001; B25F 5/02; B25B 21/007; B25B 21/00

(57) ABSTRACT

A device for installing expansion bolts includes a case with a first motor located therein which is connected with a direction switch. A first transmission shaft is connected to the first shaft of the first motor, and drives a rotary unit. A movable unit is connected to the rotary unit which drives the movable unit linearly. A fixed member is connected to the front end of the case. When an expansion bolt extends through a plaster wall, a bolt head of a bolt is engaged with the first notch of the movable unit. The first motor is then activated to co-rotate the first transmission shaft and the rotary unit to drive the movable unit linearly, so that the sleeve of the expansion bolt expands outward to contact the inside surface of the plaster wall.

### BACKGROUND OF THE INVENTION

### 1. Fields of the Invention

The present invention relates to a device for installing expansion bolts, and more particularly, to a multiple-function device that is able to drill and installing expansion bolts.

### 2. Descriptions of Related Art

The plaster walls are widely used in houses and buildings because the plaster walls are green material and have better sound isolation feature. Usually, when installing the plaster walls, the plaster walls are drilled to have holes, and expansion bolts are hammered into the holes until that the sleeve passes over the hole and the end portion of the expansion bolt touches the outside surface of the plaster wall. Then the user holds the end portion and operates the nut that is threadedly connected to other end of the expansion bolt so that the sleeve of the expansion bolt expands outward to contact against the inside surface of the plaster wall. The final step is to remove the bolt from the plaster wall. In other words, the users have to prepare an electric driller with a drill, a hammer and a screwdriver to install the expansion bolts. The efficiency for installation of the expansion bolts is low, especially when installing the expansion bolts at a high position.

The present invention is intended to provide a device that is able to drill and install the expansion bolt so as to eliminate the drawbacks mentioned above.

### SUMMARY OF THE INVENTION

The present invention relates to a device for installing expansion bolts, and comprises a case having a first motor located therein which has a first shaft. A direction switch and a power supply are respectively electrically connected to the first motor. A first transmission shaft is connected to the first shaft of the first motor. A rotary unit is connected to the first transmission shaft and driven by the first transmission shaft. A movable unit is connected to the rotary unit which drives the movable unit linearly. A fixed member is connected to the front end of the case. A circuit is formed between the first motor, the power supply and the direction switch. The rotary unit has a bore defined centrally therein, and threads are defined in the outer periphery of the rotary unit so as to be threadedly engaged with a toothed portion of the movable unit to drive the movable unit. The movable unit has a rail and an upright board is connected to the rail. The upright board includes a first notch. The fixed member is connected to the front end of the case and has a front board which has a second notch.

When an expansion bolt extends through a plaster wall, and a first end of the expansion bolt contacts the front board of the fixed member, the bolt head of the bolt of the expansion bolt is engaged with the first notch of the movable unit. The first motor is then activated to co-rotate the first transmission shaft and the rotary unit so as to drive the movable unit linearly. Therefore, the bolt body of the bolt moves toward the bolt head so as to expand the sleeve outward between the first end and the second end of the expansion bolt to contact the inside surface of the plaster wall.

Preferably, the device comprises a wherein a second motor that is located in the case and has a second shaft which is connected with a second transmission shaft. The second transmission shaft is movably inserted into a driving shaft which is retractably movable relative to the second transmission shaft. The second motor is electrically connected to the function switch that is connected to the case. The function switch includes a front micro switch which controls a circuit between the second motor, the power supply, the direction switch and the front micro switch. When the drill bit or the screwdriver bit on the driving shaft and contacts the function switch, the second motor is activated to drive the second transmission shaft which drives the driving shaft, so that the drill bit or the screwdriver bit on the driving shaft rotates to easily drill a hole or to retrieve a bolt.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the device of the present invention;

FIG. 2 is an exploded view of the device of the present invention;

FIG. 3 is a side cross sectional view of the device of the present invention;

FIG. 4 is a cross sectional view to show that the device in FIG. 3 drills through the plater wall;

FIG. 5 shows that the device of the preset invention is to install an expansion bolt;

FIG. 6 shows that the device of the preset invention installs an expansion bolt, and

FIG. 7 shows that the device of the preset invention removes the bolt from the expansion bolt.

### DETAILED DESCRIPTION OF THE PREFERRED EMBODIMENT

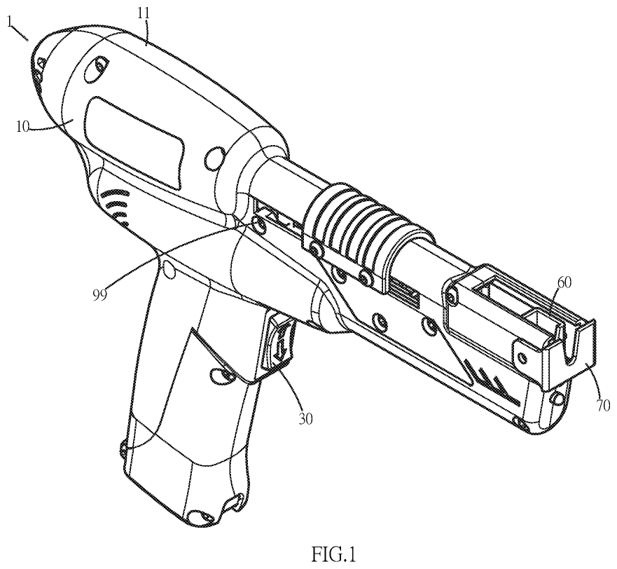

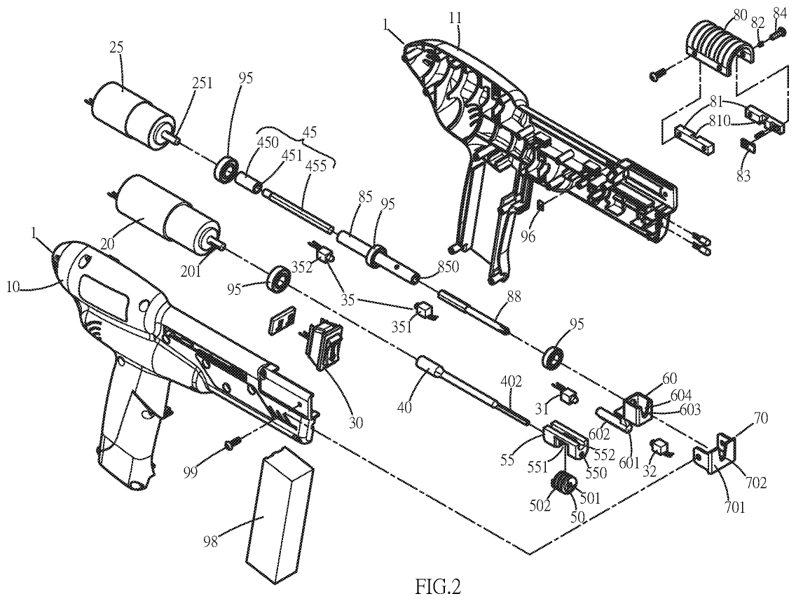

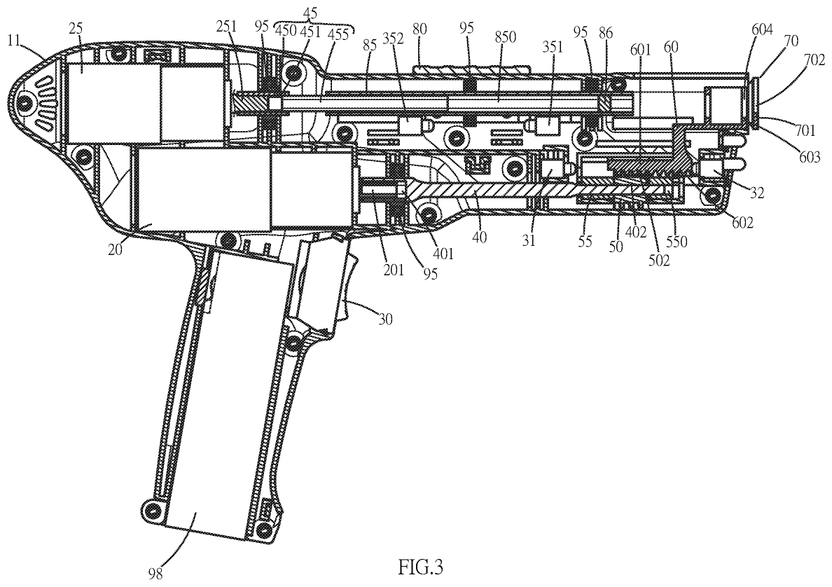

Referring to FIGS. 1 to 7, the device of the present invention comprises a case 1, and a first motor 20 and a second motor 25 are respectively installed in the case 1. The first motor 20 has a first shaft 201. A direction switch 30 and a power supply 98 are respectively and electrically connected to the first motor 20. A function switch 35 is connected to the second motor 25. A first transmission shaft 40 is connected to the first shaft 201 of the first motor 20. A second transmission shaft 45 is connected to the second shaft 251 of the second motor 25. A rotary unit 50 is connected to the first transmission shaft 40 and driven by the first transmission shaft 40. A movable unit 60 is connected to the rotary unit 50 which drives the movable unit 60 linearly. The movable unit 60 has a rail 601 and an upright board 603 connected to the rail 601. The rail 601 includes a toothed portion 602. A fixed member 70 is connected to the front end of the case 1. A driving shaft 85 is retractably connected to the second transmission shaft 45. The case 1 is composed of a first part 10 and a second part 11 by multiple locking members 99 so as to install the first motor 20, the second motor 25, a restriction member 55, a bearing 99 and an L-shaped fixing member 96 in the case 1. The direction switch 30, the function switch 35 and the fixing member 70 are fixed to the case 1.

A circuit is formed between the first motor 20, the power supply 98 and the direction switch 30. Alternatively, the first motor 20, the power supply 98, the direction switch 30, the rear micro switch 352 of the function switch 35 forms the first main circuit. By different directional touch to the direction switch 30, the first shaft 201 of the first motor 20 rotates clockwise or counter clockwise. A first switch 31 and a second switch 32 are connected to the first main circuit, wherein the first switch 31 and the second switch 32 respectively control two opposite direction of movement of the movable unit 60 by providing a specific current to the first motor 20. Specifically, the first switch 31 cuts a first directional current to the first motor 20 and then provides a second directional current to the first motor 20 which then rotates in opposite direction. The second switch 32 cuts the current when the movable unit 60 returns to its initial position.

The second motor 25, the power supply 98, the direction switch 30, and the front micro switch 351 of the function switch 35 forms the second main circuit. The second main circuit controls the second shaft 251 of the second motor 25 to rotate clockwise or counter clockwise when the direction switch 30 is touched from different directions. The output of the second motor 25 is smaller than that of the first motor 20.

The first transmission shaft 40 includes a non-circular recess 401 (such as a hexagonal recess) defined in one end thereof, and a non-circular extension 402 (such as a D-shaped extension) extending from the other end of the first transmission shaft 40. The first shaft 201 is inserted into the non-circular recess 401, and the non-circular extension 402 extends through the positioning hole 550 of the restriction member 55, and then is inserted into the non-circular bore 501 of the rotary unit 50. The first transmission shaft 40 directly drives the rotary unit 50.

The second transmission shaft 45 includes a tubular part 450 mounted to the second shaft 251 of the second motor 25, and a rod 455 is inserted into the tubular part 450. The tubular part 450 is secured to the second shaft 251 by a pin or a bolt (not shown) and includes a polygonal passage 451. Two ends of the rod 455 are respectively inserted into the polygonal passage 451 and the axial hole 850 of the driving shaft 85. The two ends of the rod 455 each have a shape corresponding to the polygonal passage 451 and the axial hole 850.

The restriction member 55 has a recess 551 defined in the underside thereof. Two positioning holes 550 are defined through the restriction member 55 from two ends thereof and communicate with the recess 551. A guide groove 552 is defined in the top of the restriction member 55 and parallel with the positioning holes 550 which is used to guide the first transmission shaft 54, and also to guide the rotary unit 50 to be restricted at the recess 551, so that the threads 502 of the rotary unit 50 are inserted into the guide groove 552 to be engaged with the toothed portion 602 of the movable unit 60. The guide groove 552 guides the direction that the movable unit 60 moves.

The rotary unit 50 having the bore 501 defined centrally therein, and threads 502 are defined in the outer periphery of the rotary unit 50 and threadedly engaged with the toothed portion 602 of the movable unit 60 so as to drive the movable unit 60.

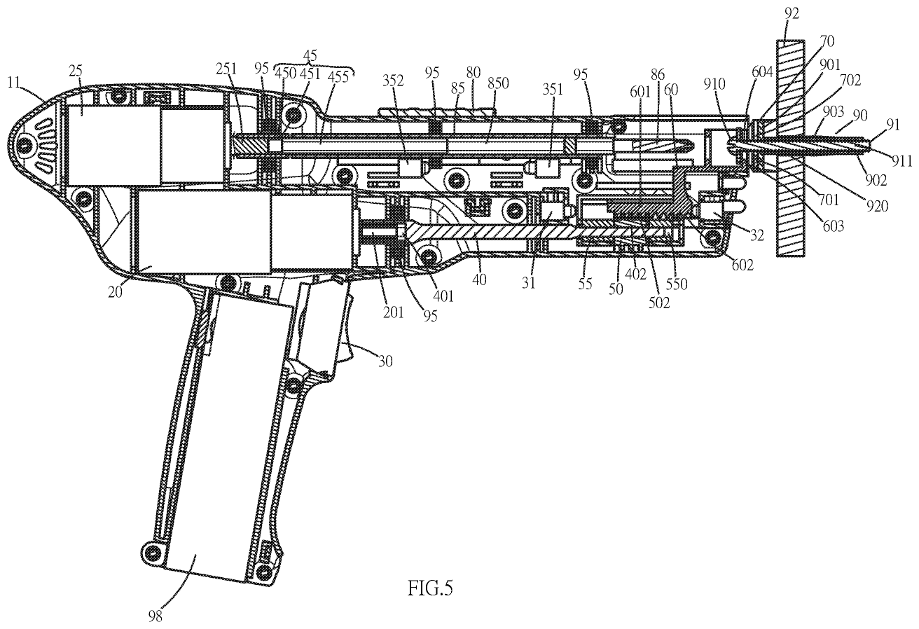

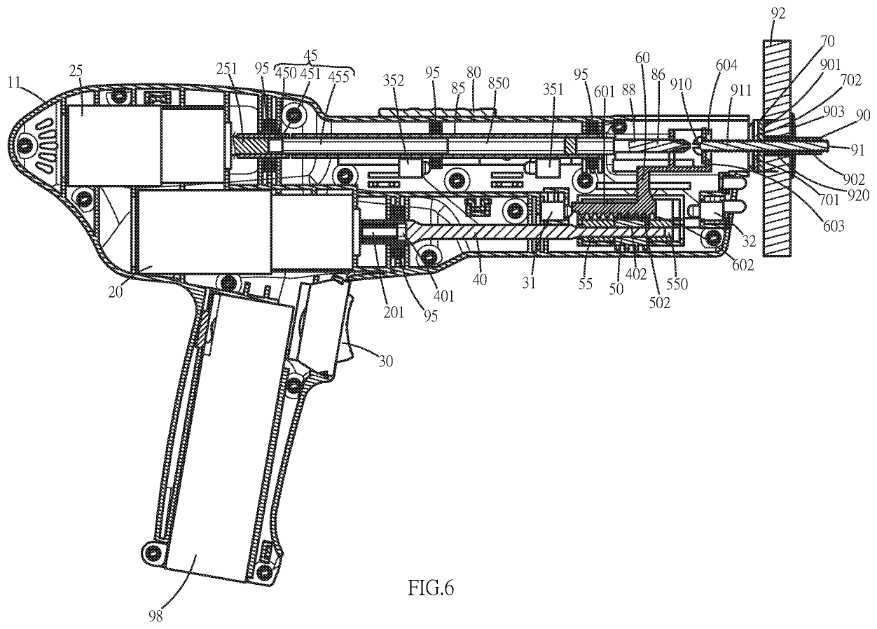

The movable unit 60 includes a first notch 604 so that the bolt body 911 of the bolt 91 of the expansion bolt 90 is engaged with the first notch 604, and the first end 910 is engaged with the inside of the upright board 603 as shown in FIGS. 5 and 6.

The fixed member 70 is connected to the front end of the case 1 and has a front board 701 which has a second notch 702 so that screwdriver bit 8 or a drill bit 89 or a part such as the bolt 91 may extend through the second notch 702.

The axial hole 850 of the driving shaft 85 is a polygonal hole, and a magnet 86 is received in the polygonal axial hole 850. A bearing 95 is mounted to the driving shaft 85 which is movable with a shifting member 80 that is slidably connected to the case 1. The shifting member 80 has a restriction member 81 connected to at least one of two lateral sides thereof. The restriction member 81 has a restriction notch 810 defined in the inside thereof. An adjustment bolt 84 extends through a spring 82 and the restriction member 81 and is located to a hook member 83 so that the hook member 83 can hook to the L-shaped fixing member 96 of the case 1 to position the shifting member 80 after the shifting member 80 moves forward.

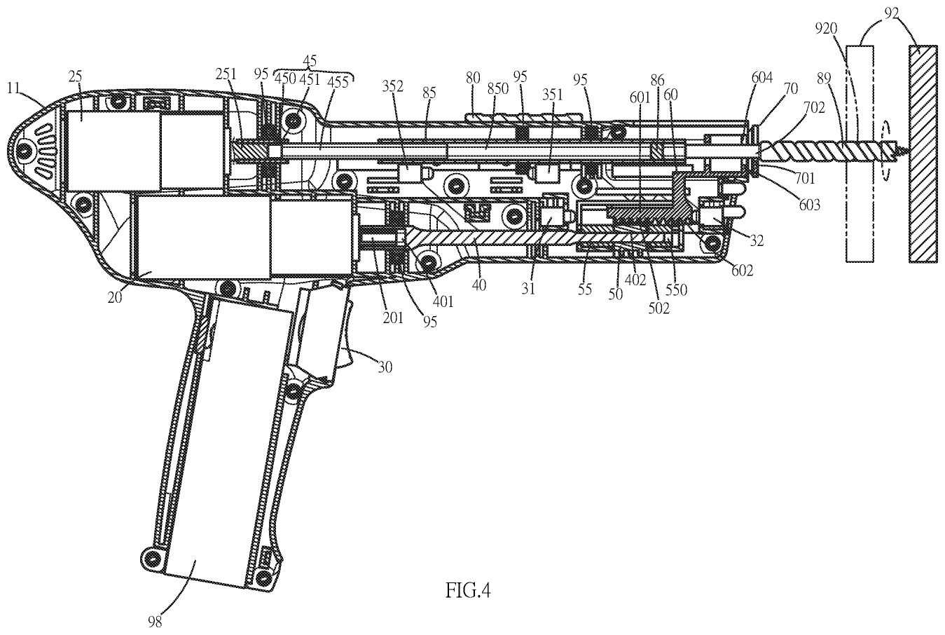

When fixing a plaster wall 92 to a column or to hang an object on the plaster wall 92, the shifting member 80 is first shifted forward to drive the driving shaft 85 to move forward until the hook member 83 hooks to the L-shaped fixing member 96 of the case 1. The bearing 95 compresses the front micro switch 351 of the function switch 35 so as to form the second main circuit between the second motor 25, the power supply 98, the direction switch 30, and the front micro switch 351 of the function switch 35. Then, the drill bit 98 is inserted into the second notch 702 of the fixing member 70 and the first notch 604 of the rotary unit 60, and is inserted into the axial hole 850 of the driving shaft 85. By pressing the direction switch 30, the second shaft 251 of the second motor 25 rotates and drives the second transmission shaft 45 and the driving shaft 85, so that the drill bit 89 drills a through hole 920 through the plaster wall 92 as shown in FIG. 4.

The drill bit 89 is removed and the screwdriver bit 88 is inserted into the axial hole 850. The shifting member 80 is then shifted in opposite direction until shifting member 80 drives the driving shaft 85 and the bearing 95 to touch the rear micro switch 352 to form the first main circuit between the first motor 20, the power supply 98, the direction switch 30, and the rear micro switch 352 of the function switch 35. The expansion bolt 90 is then inserted into the through hole 920 of the plaster wall 92, and the first end 901 of the expansion bolt 90 contacts the outside of the front board 701 of the fixed member 70. The bolt head 910 of the bolt 91 that is connected to the second end 902 of the bolt 91 contacts the inside of the upright board 603 of the movable unit 60 as shown in FIG. 5.

By touching the direction switch 30, the first motor 20 is activated to co-rotate the first transmission shaft 40 and the rotary unit 50 so as to drive the movable unit 60 linearly. In other words, when the movably unit 60 moves to the left, the upright board 603 pulls the bolt head 910 of the bolt 91 to the left, so that the sleeve 903 expands outward between the first end 901 and a second end 902 and contacts the inside surface of the plaster wall 92 as shown in FIG. 6.

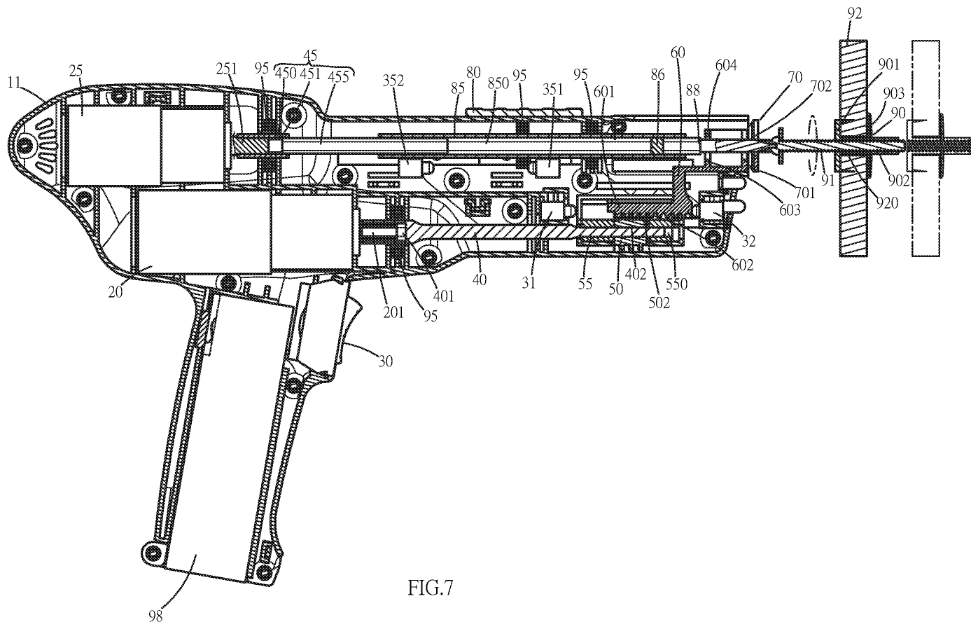

The user then pushes the shifting member 80 and the driving shaft 85 the right (forward) until the hook member 83 hooks the L-shaped fixing member 96, and the bearing 95 on the driving shaft 85 compresses the front micro switch 351 of the function switch 35 to form the second main circuit again. The screwdriver bit 88 is moved along with the movement of the shifting member 80 until the screwdriver bit 88 is engaged with the bolt head 910. The direction switch 30 is pushed in the opposite direction to activate the second motor 25 so that the second shaft 251 rotates in the opposite direction to drive the screwdriver bit 88 to unscrew the bolt 91 out from the expansion bolt 90 as shown in FIG. 7. The device of the present invention can drill, install the expansion bolt 90 and remove the bolt 91 from the expansion bolt 90.

While we have shown and described the embodiment in accordance with the present invention, it should be clear to those skilled in the art that further embodiments may be made without departing from the scope of the present invention.

What is claimed is:

1. A device for installing expansion bolts, comprising:
a case having a first motor located therein which has a first shaft, a direction switch and a power supply respectively electrically connected to the first motor, a first transmission shaft connected to the first shaft of the first motor, a rotary unit connected to the first transmission shaft and driven by the first transmission shaft, a movable unit connected to the rotary unit which drives the movable unit linearly, a fixed member connected to a front end of the case, a circuit being formed between the first motor, the power supply and the direction switch;
the rotary unit having a bore defined centrally therein, threads being defined in an outer periphery of the rotary unit and threadedly engaged with a toothed portion of the movable unit so as to drive the movable unit;
the movable unit having a rail and an upright board connected to the rail, the upright board including a first notch;
the fixed member connected to the front end of the case and having a front board, the front board having a second notch and
wherein when an expansion bolt extends through a plaster wall, and a first end of the expansion bolt contacts the front board of the fixed member, a bolt head that is connected to a bolt is engaged with the first notch of the movable unit, the first motor is activated to co-rotate the first transmission shaft and the rotary unit so as to drive the movable unit linearly, a bolt body of the bolt being moved toward the bolt head so as to expand the sleeve outward between the first end and a second end of the expansion bolt to contact an inside surface of the plaster wall.

2. The device for installing expansion bolts as claimed in claim 1, wherein the rotary unit includes a restriction member which is fixed in the case and has a guide groove, the rail of the movable unit is slidably located in the guide groove.

3. The device for installing expansion bolts as claimed in claim 2, wherein the restriction member has a recess defined in an underside thereof, two positioning holes defined through the restriction member from two ends thereof and communicate with the recess, the guide groove is defined in a top of the restriction member and parallel with the positioning holes.

4. The device for installing expansion bolts as claimed in claim 1 further comprising a first switch and a second switch connected to the circuit between the first motor and the direction switch, the first switch and the second switch respectively controlling two opposite direction of movement of the movable unit.

5. The device for installing expansion bolts as claimed in claim 4 further comprising a function switch connected to the circuit between the first motor and the direction switch, the function switch including a rear micro switch which controls a first main circuit between the first motor, the power supply, the direction switch and the rear micro switch.

6. The device for installing expansion bolts as claimed in claim 4, wherein a second motor is located in the case and has a second shaft which is connected with a second transmission shaft, the second transmission shaft is movably inserted into a driving shaft which is retractably movable relative to the second transmission shaft, the second motor is electrically connected to the function switch that is connected to the case, the function switch includes a front micro switch which controls a second main circuit between the second motor, the power supply, the direction switch and the front micro switch.

7. The device for installing expansion bolts as claimed in claim 6, wherein the second transmission shaft includes a tubular part mounted to the second shaft of the second motor, and a rod is inserted into the tubular part, the tubular part is secured to the second shaft and includes a polygonal passage, two ends of the rod are respectively inserted into the polygonal passage and a axial hole of the driving shaft.

8. The device for installing expansion bolts as claimed in claim 7, wherein the axial hole of the driving shaft is a polygonal hole, a bearing is mounted to the driving shaft which is movable with a shifting member that is slidably connected to the case.

9. The device for installing expansion bolts as claimed in claim 8, wherein the shifting member has a restriction member connected to at least one of two lateral sides thereof, the restriction member has a restriction notch defined in an inside thereof, an adjustment bolt extends through a spring and the restriction member and is located to a hook member which hooks to an L-shaped fixing member of the case.

10. The device for installing expansion bolts as claimed in claim 8, wherein the driving shaft includes a magnet received in the polygonal axial hole.
